(19) United States
(12) Patent Application Publication
(10) Pub. No.: US 2024/0427980 A1
(43) Pub. Date: Dec. 26, 2024

(54) METHOD FOR DISPLAYING INFORMATION, COMPUTER DEVICE, AND STORAGE MEDIUM

(71) Applicant: Beijing Zitiao Network Technology Co., Ltd., Beijing (CN)

(72) Inventors: Qi DENG, Beijing (CN); Rongqiang HUANG, Beijing (CN)

(21) Appl. No.: 18/732,469

(22) Filed: Jun. 3, 2024

(30) Foreign Application Priority Data
Jun. 25, 2023 (CN) 202310755533.X

(51) Int. Cl. G06F 40/106; G06F 3/0482; G06F 3/0483; G06F 3/0484

(52) U.S. Cl. CPC G06F 40/106; G06F 3/0482; G06F 3/0483; G06F 3/0484

(57) ABSTRACT

A method and apparatus for displaying information, a computer device, and a storage medium are provided. The method includes: displaying at least one display element in a target display page, different display elements characterizing different content types, the different content types including different content genres and/or different numbers of books associated with the display element; in response to a target display element in any of the display element being selected, updating to display of preview information corresponding to the target display element in the target display page, wherein the preview information is associated with a content type of the target display element; and displaying reading information corresponding to the target display element in response to a triggering operation on the preview information of the target display element.

### CROSS-REFERENCE TO RELATED APPLICATIONS

The present application claims priority of the Chinese Patent Application No. 202310755533.X, filed Jun. 25, 2023, entitled “METHOD AND APPARATUS FOR DISPLAYING INFORMATION, COMPUTER DEVICE, AND STORAGE MEDIUM” the disclosure of which is incorporated herein by reference in its entirety as part of the present application.

### TECHNICAL FIELD

Embodiments of the present disclosure relate to the field of data processing technology, and in particular to a method and apparatus for displaying information, a computer device and a storage medium.

### BACKGROUND

The book reading platform may enable a user to select a book of interest to read by displaying book information such as a book cover, an author, and the like.

With a limited number of pages to display, it is difficult to balance the number of books to display and the richness of information displayed of each book. This is to provide more books to the user and also to enable the user to select the book of interest from a plurality of books through sufficient information about the book.

In this case, it is likely to display too little information, so it is difficult for the user to select the book according to the information displayed; or it is likely to display too much information, so the user needs to spend more time to read, resulting in aggravating the user's reading burden.

### SUMMARY

At least one embodiment of the present disclosure provides a method and apparatus for displaying information, a computer device, and a storage medium.

At least one embodiment of the present disclosure provides a method for displaying information, which includes: displaying at least one display element in a target display page, different display elements characterizing different content types, the different content types including different content genres and/or different numbers of books associated with the display element; in response to a target display element among the at least one display element being selected, updating to display preview information corresponding to the target display element in the target display page, the preview information being associated with a content type of the target display element; and displaying reading information corresponding to the target display element in response to a triggering operation on the preview information of the target display element.

For example, in an optional embodiment, in the target display page, the target display element is displayed in a target area in a form of card display; in response to a target display element among the at least one display element being selected, updating to display preview information corresponding to the target display element in the target display page, includes: in response to the target display element being selected, displaying a flip effect in the form of card display in the target area, and updating to display the preview information in the target area after the flip effect ends being displayed.

For example, in an optional embodiment, in response to a target display element among the at least one display element being selected, updating to display preview information corresponding to the target display element in the target display page includes: in response to the target display element being selected, enlarging the size of a first area in which the preview information is displayed to obtain a second area after enlarging, and displaying the target display element in the second area, the size of the second area being determined based on the amount of information in the preview information and a threshold of the maximum amount of information that can be carried in the second area.

For example, in an optional embodiment, in response to the target display page including a user collection page, the preview information corresponding to the target display element is determined in the following manner: in response to the number of books of the target display element being one, determining the preview information based on a book content corresponding to a target book indicated by the target display element; or, in response to the number of books of the target display element being more than one, determining a plurality of target books indicated by the target display element and determining the preview information based on book information corresponding to the plurality of target books.

For example, in an optional embodiment, in response to the target display page including a book recommendation page, the preview information corresponding to the target display element is determined in the following manner: in response to the number of books of the target display element being one, obtaining book recommendation information corresponding to a target book indicated by the target display element as the preview information; or, in response to the number of books of the target display element being more than one, determining a target booklist indicated by the target display element to determine the preview information based on booklist introduction information corresponding to the target booklist.

For example, in an optional embodiment, in response to the preview information being determined based on a book content of a book, the method further includes determining the preview information in the following manner: determining a reading progress corresponding to the book; in response to the reading progress characterizing having read the book, determining review summary information and/or abstract information of a to-be-read content of the book based on the reading progress of the book, to determine the preview information of the book based on the review summary information and/or the abstract information of the to-be-read content, the review summary information being determined by utilizing a read book content obtained from the book content based on the reading progress and the abstract information of the to-be-read content being determined by utilizing a to-be-read book content obtained from the book content based on the reading progress.

For example, in an optional embodiment, the method further includes: in response to the reading progress characterizing not having read the book, determining book abstract information for introducing the book based on the book content of the book, and obtaining a trial book content corresponding to the first chapter of the book to determine the preview information based on the book abstract information and the trial book content.

For example, in an optional embodiment, the content genre corresponding to the target display element includes an image genre; the updating to display preview information corresponding to the target display element, includes: in response to the content genre corresponding to the target display element being the image genre, determining a display position corresponding to at least one to-be-displayed image in the preview information in the target display page for displaying the preview information based on the display position, the to-be-displayed image belonging to a book content of a book corresponding to the target display element.

At least one embodiment of the present disclosure provides an apparatus for displaying information, which includes:
a first display module, configured to display at least one display element in a target display page, different display elements characterizing different content types, the different content types including different content genres and/or different numbers of books associated with the display element;
a second display module, configured to, in response to a target display element among the at least one display element being selected, update to display preview information corresponding to the target display element in the target display page, the preview information being associated with a content type of the target display element;
a third display module, configured to display reading information corresponding to the target display element in response to a triggering operation on the preview information of the target display element.

For example, in an optional embodiment, the target display element is displayed in a target area in a form of card display; the second display module, when in response to a target display element among the at least one display element being selected, updating to display preview information corresponding to the target display element in the target display page, is configured to: in response to the target display element being selected, display a flip effect in the form of card display in the target area, and update to display the preview information in the target area after the flip effect ends being displayed.

For example, in an optional embodiment, the second display module, when in response to a target display element among the at least one display element being selected, updating to display preview information corresponding to the target display element in the target display page, is configured to: in response to the target display element being selected, enlarge the size of a first area in which the preview information is displayed to obtain a second area after enlarging, and displaying the target display element in the second area, where the size of the second area is determined based on the amount of information in the preview information and a threshold of the maximum amount of information that can be carried in the second area.

For example, in an optional embodiment, in response to the target display page including a user collection page, the preview information corresponding to the target display element is determined in the following manner: in response to the number of books of the target display element being one, determining the preview information based on a book content corresponding to a target book indicated by the target display element; or, in response to the number of books of the target display element being more than one, determining a plurality of target books indicated by the target display element and determining the preview information based on book information corresponding to the plurality of target books.

For example, in an optional embodiment, in response to the target display page including a book recommendation page, the preview information corresponding to the target display element is determined in the following manner: in response to the number of books of the target display element being one, obtaining book recommendation information corresponding to a target book indicated by the target display element as the preview information; or, in response to the number of books of the target display element being more than one, determining a target booklist indicated by the target display element to determine the preview information based on booklist introduction information corresponding to the target booklist.

For example, in an optional embodiment, in response to the preview information being determined based on a book content of a book, the method further includes determining the preview information in the following manner: determining a reading progress corresponding to the book; in response to the reading progress characterizing having read the book, determining review summary information and/or abstract information of a to-be-read content of the book based on the reading progress of the book, to determine the preview information of the book based on the review summary information and/or the abstract information of the to-be-read content, where the review summary information is determined by utilizing a read book content obtained from the book content based on the reading progress and the abstract information of the to-be-read content is determined by utilizing a to-be-read book content obtained from the book content based on the reading progress.

For example, in an optional embodiment, further including determining the preview information in the following manner: in response to the reading progress characterizing not having read the book, determining book abstract information for introducing the book based on the book content of the book, and obtaining a trial book content corresponding to the first chapter of the book to determine the preview information based on the book abstract information and the trial book content.

For example, in an optional embodiment, the content genre corresponding to the target display element includes an image genre; updating to display preview information corresponding to the target display element includes: in response to the content genre corresponding to the target display element being the image genre, determining a display position corresponding to at least one to-be-displayed image in the preview information in the target display page for displaying the preview information based on the display position, the to-be-displayed image belonging to a book content of a book corresponding to the target display element.

At least one embodiment of the present disclosure provides a computer device, including: at least one processor and at least one memory, where the at least one memory stores machine-readable instructions executable by the processor, the at least one processor is configured to execute the machine-readable instructions stored in the at least one memory, and the machine-readable instructions when executed by the processor implements the steps in any of the aforementioned optional embodiments.

At least one embodiment of the present disclosure provides a non-transient computer-readable storage medium, where the non-transient computer-readable storage medium stores computer programs, and the computer programs upon being executed, implement the steps in any of the aforementioned optional embodiments.

In order to make the aforementioned objects, features, and advantages of the present disclosure more obvious and understandable, embodiments accompanied with the drawings are described in detail below.

### BRIEF DESCRIPTION OF DRAWINGS

In order to more clearly illustrate the technical scheme of the embodiments of the present disclosure, the drawings required to be used in the embodiments will be briefly described below. The drawings herein are incorporated into and form a part of the specification, which illustrate embodiments consistent with the present disclosure and are used in conjunction with the specification to illustrate the technical schemes of the present disclosure. It should be understood that the following drawings show only certain embodiments of the present disclosure, and therefore should not be regarded as limiting the scope, and that other relevant drawings may be obtained from these drawings by a person of ordinary skill in the art without creative work.

FIG. 1 illustrates a flowchart of a method for displaying information provided by an embodiment of the present disclosure;

FIG. 2 illustrates a schematic diagram of a target display page provided by an embodiment of the present disclosure;

FIG. 3 illustrates a schematic diagram of updating to display preview information in a target area after the end of a flip effect provided by an embodiment of the present disclosure;

FIG. 4 illustrates a schematic diagram of preview information displayed in a second area provided by an embodiment of the present disclosure;

FIG. 5 illustrates a schematic diagram of displaying preview information of a target display element on a user collection page provided by an embodiment of the present disclosure, where the target display element indicates a book that has been read;

FIG. 6 illustrates another schematic diagram of displaying preview information of a target display element on a user collection page provided by an embodiment of the present disclosure, where the target display element indicates a book that has not been read;

FIG. 7 illustrates a schematic diagram of displaying preview information of a target display element on a user collection page provided by an embodiment of the present disclosure, where the target display element indicates a book list;

FIG. 8 illustrates a schematic diagram of displaying preview information of a target display element on a book recommendation page provided by an embodiment of the present disclosure, where the target display element indicates a book;

FIG. 9 illustrates a schematic diagram of displaying preview information of a target display element on a book recommendation page provided by an embodiment of the present disclosure, where the target display element indicates a book list;

FIG. 10 illustrates a schematic diagram of displaying preview information corresponding to a target display element of an image genre provided by an embodiment of the present disclosure;

FIG. 11 illustrates a schematic diagram of an apparatus for displaying information provided by an embodiment of the present disclosure; and

FIG. 12 illustrates a schematic diagram of a computer device provided by an embodiment of the present disclosure.

### DETAILED DESCRIPTION

In order to make the objects, technical scheme and advantages of the embodiments of the present disclosure clearer, the technical scheme in the embodiments of the present disclosure will be described clearly and completely in the following in conjunction with the drawings in the embodiments of the present disclosure, and it is clear that the embodiments described are only a portion of the embodiments of the present disclosure and not all of the embodiments. The components of embodiments of the present disclosure generally described and illustrated herein may be arranged and designed in a variety of different configurations. Thus, the following detailed description of embodiments of the present disclosure is not intended to limit the scope of the present disclosure for which protection is claimed, but rather represents only selected embodiments of the present disclosure. Based on the embodiments of the present disclosure, all other embodiments obtained by a person skilled in the art without making creative works belong to the scope of protection of the present disclosure.

It is found that in the book reading platform, a book is recommended to the user by displaying book information. When the book information of a book is displayed on a page, if the information displayed on the page is limited, it is difficult for the user to select a book that the user wants to read through the limited information provided. If too much information is displayed on the page, because of the limitation of the page length, on the one hand, fewer books can be displayed, and on the other hand, if the user wants to select the book of interest, it takes a relatively long time to read the information displayed of each book individually, which may aggravate the reading burden of the user.

At least one embodiment of the present disclosure provides a method for displaying information in which a display element (a book or a book list) including different genres and different numbers of books is firstly displayed in a target display page, and a larger number of elements (a book and/or a book list) can be displayed in the target display page because the content of the display element is concise. After viewing each display element, the user can select the target display element of interest and view the updated and displayed preview information associated with the content of the target display element on the target display page, i.e., to realize the targeted display of more abundant book information of the book or book list of interest to the user. For the user who continues to confirm the information he/she wants to read by the updated and displayed preview information, specific reading information can be displayed according to the triggering operation on the preview information.

This approach breaks the limitations on the way of displaying information in the page. Compared with the way of displaying information in the page in a fixed manner, the user's need for information acquisition can be judged based on the user's actual operation, so as to update and provide the information that the user wishes to acquire in the next step in a targeted manner. Therefore, it is possible to provide detailed book information according to the user's actual needs while displaying the diversity of books in order to reduce the user's reading burden.

All of the above are the results of the inventor's practice and careful study, therefore, the discovery process of the above problems and the solutions proposed in the present disclosure below for the above problems should be the inventor's contribution to the present disclosure in the process of the present disclosure.

It should be noted that in the present disclosure, similar symbols and letters denote similar items in the following drawings, and therefore, once an item is defined in one drawing, no further definition and explanation of it is required in the subsequent drawings.

In order to facilitate the understanding of the embodiments of the present disclosure, a method for displaying information disclosed in an embodiment of the present disclosure is first described in detail. The execution subject of the method for displaying information provided in the embodiments of the present disclosure is generally a computer device having a certain computing power, which computer device includes, for example, a terminal device, or a server or other processing device, and the terminal device may be a user equipment (UE), a mobile device, a user terminal, a terminal, a cellular phone, a cordless phone, a personal digital assistant (PDA), a handheld device, a computing device, an in-vehicle device, a wearable device, and the like. In some possible implementations, the method for displaying information can be realized by means of a processor calling computer-readable instructions stored in a memory.

The method for displaying information provided by at least one embodiment of the present disclosure is described below.

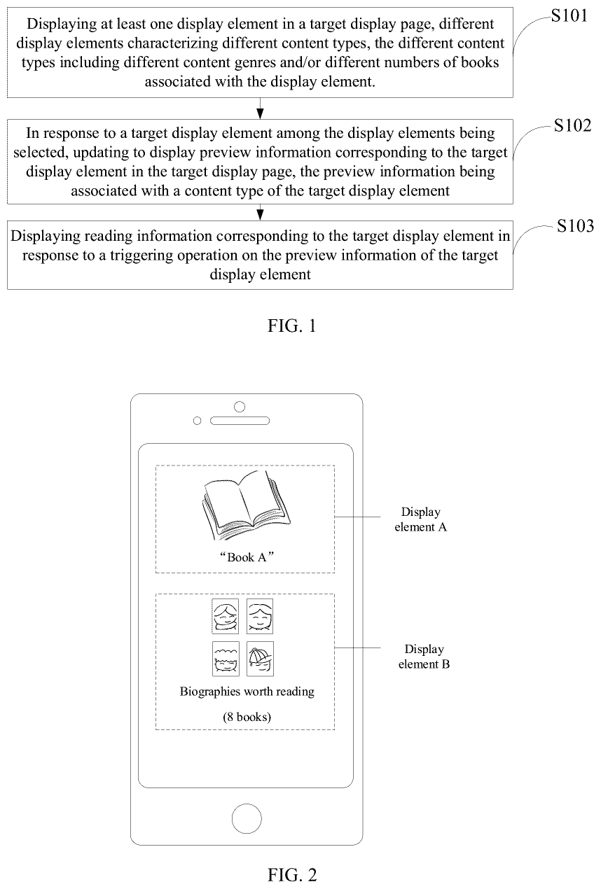

FIG. 1 illustrated a flowchart of a method for displaying information provided by an embodiment of the present disclosure. The method includes S101-S103.

S101, displaying at least one display element in a target display page, different display elements characterizing different content types, the different content types including different content genres and/or different numbers of books associated with the display element.

S102, in response to a target display element among the display elements being selected, updating to display preview information corresponding to the target display element in the target display page, the preview information being associated with a content type of the target display element.

S103, displaying reading information corresponding to the target display element in response to a triggering operation on the preview information of the target display element.

The examples of aforementioned S101-S103 are described in detail as follows.

For the aforementioned S101, the target display page and the display element are first described separately. In the embodiment of the present disclosure, the target display page is specifically used for displaying the display element corresponding to a book or a book list including a plurality of books, and is different from the book reading page where a specific book content may be read, and specifically assumes the function of displaying book information corresponding to a plurality of books and/or a book list. In the embodiments of the present disclosure, the target display page may be specifically subdivided into a user collection page and a book recommendation page depending on the source of the book and/or the book list therein. For the user collection page, the book and/or the book list included therein are determined based on the user's collection operation, and because the user has collected the book and/or the book list, the corresponding specific book content may have been partially or completely read by the user. For the book recommendation page, the book and/or the book list therein may be promoted by the reading platform to the user, and in one possible case, the reading platform may recommend books to the user that have not been selected for reading and collecting.

The display element displayed in the target display page is specifically used to represent a book or a book list, and has different specific display contents depending on the content type the display element corresponds to. Here, the different content types include different content genres and/or different numbers of associated books. The number of associated books is specifically intended to characterize whether the display element is specifically representative of a book or a book list. If the number of books associated with the display element is 1, the display element represents a book; if the number of books associated with the display element is an integer greater than 1, the display element represents a book list.

The content genre may include a text genre. For example, for a book of the genre of a novel, a biography, etc., the content genre characterized by the display element corresponding to the book is the text genre. In addition, the content genre may further include an image genre. For example, for a book of the genre of a comic book, a photography album, etc., the content genre characterized by the display element corresponding to the book is the image genre.

In other words, in the target display page, the book and/or the book list of the text genre and/or the image genre may be displayed, and may be specifically displayed through the display element in the target display page.

The following describes the specific approach of displaying the at least one display element in the target display page.

In one possible case, the target display element may be displayed in a target area in a form of card display. Exemplarily, FIG. 2 illustrated a schematic diagram of a target display page provided by an embodiment of the present disclosure. In the target display page, a display element A and a display element B are illustrated in an example form. The display element A specifically represents a book, the display element B specifically represents a book list, and the card corresponding to each display element is labeled by a dotted line box, i.e., the area labeled by the dotted line box is the target area of the target display page for displaying the display elements in the target display page when the form of card display is selected as illustrated in the embodiments of the present disclosure. Alternatively, in other possible cases, the display elements may also be displayed in the form of a list or other forms, the details of which will not be enumerated herein.

In order to convey the book or the book list represented by the display element to the user, in embodiments of the present disclosure, it is specifically selected to determine the display element of the book utilizing the cover image of the book and the name of the book, and it is selected to determine the display element of the book list utilizing the cover images corresponding to the plurality of books contained in the book list, respectively, as well as the name of the book list. Here, the name of the book list may be predetermined, such as the name of the book list determined at the time of generating the book list, or it may be automatically generated based on the book types and the like of each of the books contained in the book list, which is not limited.

In the schematic diagram illustrated in FIG. 2, for example, for the display element indicating the book, the corresponding book cover and book name of the book are shown. For the display element indicating the book list, the book covers corresponding to several of the books in the list are shown, and the number of books included therein is introduced by the label “8 books”.

Besides, in some possible cases, in addition to the aforementioned book information, the reading progress of the book or the reason for the recommendation may also be briefly described, such as labeling “Chapter 2/100 Chapters” to briefly describe the reading progress of the books that have been read by the user in the user collection page, or labeling “Hot books on the site”, to recommend the books recommended to the user in the book recommendation page for a brief explanation of the reasons for the recommendation. The specifics can be determined according to the actual situation and are not repeated here.

For the aforementioned S102, after displaying at least one display element in the target display page, the user can further select the book list or the book that he or she wants to continue to learn in depth through the information displayed therein, then a selection operation may be specifically performed to update to display the preview information corresponding to the selected target display element in the target display page. Here, the selection operation may be a hover operation or a touch operation, which is a simple operation that can be realized to achieve further information supplementation of the display element and minimize the increase in the display page, so that is easier for the user to operate whether the user selects to turn off the display of the preview information corresponding to the current target display element, or continues to jump to the book reading page of the reading information.

In a specific implementation, following the aforementioned example, for the target display element displayed in the target area in the form of card display, in order to minimize the addition of new pages, it is specifically possible to display a flip effect in the target area in the form of card display in response to the target display element being selected, and to update to display the preview information in the target area after the end of the display of the flip effect.

In other words, in the embodiments of the present disclosure, after the user selects the target display element, only the target area may be updated to display in the target display page, and it is not necessary to update to display the other display elements. In addition, it is also possible to display to the user by means of the flip effect that the update of information occurs in the area corresponding to the selection of the display element only, and the display form of the flip effect is also helpful to differentiate between a plurality of display elements.

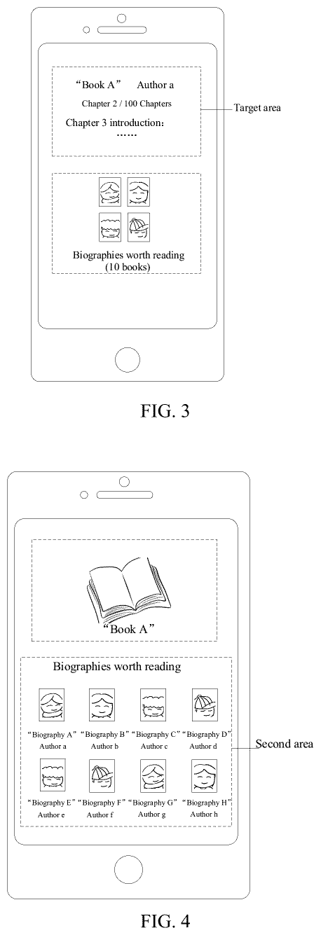

The following is illustrated by way of example, for the display element corresponding to the book A shown in FIG. 2, if it is selected as the target display element, the corresponding preview information displayed may exemplarily include the name of the book, the author information, the total number of chapters of the book and the number of chapters currently being read, as well as a brief description of the content of the next chapter to be read. For example, FIG. 3 is a schematic diagram of updating to display preview information in the target area after the end of the flip effect provided by an embodiment of the present disclosure. Compared to FIG. 2, only the target area corresponding to book A has undergone a change in the display information, and the preview information corresponding to book A is specifically displayed.

In another possible case, in order to reduce trigger operations such as up and down sliding and page turning that the user needs to perform, the preview information can be completely displayed in a single page. In the embodiments of the present disclosure, for the target display element corresponding to the preview information occupying a relatively large space, the preview information may also be presented by enlarging the display.

In a specific implementation, in response to the target display element being selected, the size of a first area in which the preview information is displayed may be enlarged to obtain a second area after enlarging, and the target display element may be displayed in the second area; the size of the second area is determined based on the amount of information of the preview information and a threshold value of the maximum amount of information that can be carried in the second area.

For example, for the display element B illustrated in FIG. 2, the preview information corresponding thereto may be indicative of the book name and book cover corresponding to each book in the book list. And because the book list specifically includes 8 books, displaying the book names and book covers corresponding to all of the books in a flat way is difficult to realize in the area corresponding to the existing display element B for clear display. Therefore, the size of the first area of the preview information may be enlarged, and then the target display element can be displayed in a second area in which the size of the display area after enlarging is larger. Here, the first area for displaying the preview information may be an area corresponding to the display area corresponding to the display element, i.e., an area with the same scope of the delineated area in the target display page.

Specifically, it may be determined whether the first area needs to be enlarged in size by counting the amount of information in the preview information. For example, it may be pre-determined that when the preview information includes less than 4 pictures or less than 3 paragraphs of text, the preview information may be completely displayed in the original first area, and if the amount of information exceeds the aforementioned amount of information, it is necessary to enlarge the display.

In determining the size of the second area, namely, in determining the size to which the first area should be enlarged, it may be specifically determined according to the amount of information of the preview information and the maximum amount of information that can be carried in the second area. Specifically, the second area of the enlarged display, specifically while realizing that the preview information can be displayed, can be set to not occupy as much as possible the display area corresponding to the other display elements in the target display page, or to minimize the blocking of the effective text, images, and other information in the other display area, and thus the second area can have the maximum size, i.e., the maximum information amount threshold to be able to be completely displayed in the interface. In the case of judging that the preview information does not exceed the threshold of the maximum amount of information, according to the actual amount of information, the size of the second area may be determined so that the preview information may be displayed flatly in the second area, and an interval may be left that allows the information therein to be differentiated, rather than displaying the information in a centralized stack, causing a burden of reading.

Exemplarily, FIG. 4 is a schematic diagram of a preview information displayed in a second area provided by an embodiment of the present disclosure, the corresponding area of which is larger in size compared to the display area corresponding to the display element A in FIG. 2, and the corresponding covers, names and authors of the 8 books can be displayed completely.

In the case of judging that the preview information exceeds the threshold of the maximum amount of information, the display size of each of the information may be selected to be reduced according to the actual situation, such as reducing the proportion of the cover image of the book to be displayed, or reducing the font size of the book name. Alternatively, a window sliding component may be provided so that the user can view all the preview information by simple sliding operations. Alternatively, the preview information may be made in the form of a moving picture, and a frame-by-frame image display may be automatically provided to the user in a form similar to a switching slide show to provide the preview information. The aforementioned is only an example of a specific way that may be selected, and no specific limitation is made herein.

In addition to the aforementioned description of a plurality of different ways of displaying the preview information, the following describes how the preview information is determined. According to the aforementioned embodiments, the target display page involved in the embodiments of the present disclosure may include a user collection page and a book recommendation page, and the books displayed in different display pages (including the book displayed directly and the books in the book list) are different, and are reflected in whether they belong to the books that the user has actively collected and/or read, or whether they belong to the books that the reading platform recommends to the user. For different books, the focus of the preview information is also different, for example, for books that have been read or collected by the user, the focus is on previewing the content of the chapters to be read; for books recommended by the reading platform to the user, the focus is on introducing the book to the user as well as providing the reasons for the recommendation.

The following is an example of how to determine the preview information corresponding to the target display element when the target display page is the user collection page or the book recommendation page.

First, for the case where the target display page includes the user collection pages, the focus is specifically on displaying content to the user that can be read further in the book. For the different cases where the target display element indicates a book and a book list, which can be specifically determined based on the number of books of the corresponding content type of the target display element. Therefore, in a specific implementation, there are two different cases of determining preview information specifically in the user collection page, including:

(1.1) determining the preview information when the target display element indicates a book.

In that case, the number of books for the target display element is one. Specifically, the preview information may be determined based on the book content corresponding to the target book indicated by the target display element.

Here, because the target display element specifically selected by the user is a book, it can be considered that the purpose of selection is to confirm whether the user wants to read the book content. When determining the preview information, the trial book content may be given prior to the user, so that the user can know the content that can be read directly when selecting the book for reading through the preview information.

For a book in the user collection page, it may be a book that the user chooses to collect during the reading process, or it may be a book that the user collects with interest, but has not read. For the aforementioned two different book collection scenarios, the way to determine the preview information are also emphasized. For example, for the book that user has read, in order to facilitate the user to review what he or she has read, the content of the book that the user has read may be summarized and displayed, and in addition, the content that can be read after selecting to read may be displayed in advance. As for the book that the user has not read, an abstract of the book may be determined based on the content of the entire book to be displayed to the user, thereby helping the user to determine whether to read the book in detail.

According to the aforementioned description, specifically, when the book content of the book is utilized to determine the preview information, the reading progress corresponding to the book may be determined first, and the reading progress determined here can distinguish whether the selected book is a book that the user has read or a book that the user has not read. For example, if the reading progress indicates that the user has read up to chapter 2, it means that reading has occurred; if the reading progress indicates that the user is ready to read Chapter 1, it means that reading has not yet occurred.

In a possible case, if it is determined that a book has been read based on the reading progress, the review summary information and/or the abstract information of the to-be-read content of the book may be determined based on the reading progress of the book, so as to determine the preview information of the book based on the review summary information and/or the abstract information of the to-be-read content.

For example, if the reading progress indicates that the user has read up to chapter 2, the book content of chapter 1 may be utilized first to determine the review summary information, i.e., to acquire the read book content from the book content based on the reading progress. The review summary information may be limited to a number of words to briefly summarize the read book content, and may be set manually or generated autonomously by a trained relevant model. In this way, the user can quickly recall what has been read in the book by the review the summary information.

In addition, the reading progress may also be utilized to determine the to-be-read book content, and the to-be-read book content may be determined to be a later chapter or more chapters of the book according to the actual situation. Abstract information can be provided to users by utilizing the to-be-read book content, so that the user can know what content is to be read if the book is selected for reading. Exemplarily, the abstract information of the to-be-read content may be obtained by summarizing the to-be-read book content in a similar manner as the review summary information, or the specific to-be-read book content may be directly displayed, so that the user can judge whether the user is interested in the actual content of the book by reading the content of the book and select whether to continue to read the specific content of the book.

In the case where the book is a read book, the aforementioned-determined review summary information and the abstract information may be displayed selectively or both, and therefore the preview information corresponding to the determined book may include at least one of the review summary information and the abstract information.

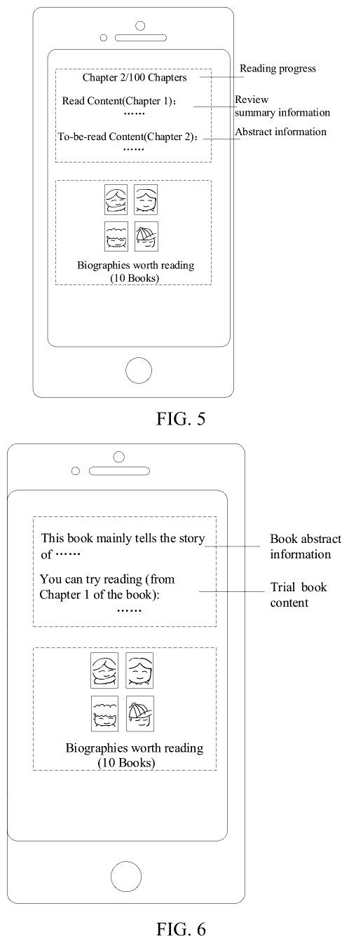

Exemplarily, FIG. 5 is a schematic diagram of displaying preview information of a target display element on a user collection page provided by an embodiment of the present disclosure, where the target display element indicates a book that has been read. In the example diagram, the display element corresponding to the book A in the corresponding example of FIG. 2 aforementioned is selected as the target display element, and the corresponding preview information is displayed after selection, which specifically includes the review summary information and the abstract information, and additionally displays the reading progress for the user's reference. In addition, it may also display the update status of the book, whether there has been a recent update of new chapters and other information.

In another possible case, if it is determined that the book has not been read based on the reading progress, book abstract information for introducing the book may be determined based on the book content of the book, and the trial book content corresponding to the first chapter of the book may be acquired to determine the preview information based on the book abstract information as well as the trial book content. In this way, utilizing the book abstract information enables the user to have a general understanding of the book content of the entire book, and utilizing the trial book content corresponding to the first chapter also enables the user to determine whether or not to continue reading thereof based on the user's own reading preferences.

Here, the way of determining the book abstract information through the book content of the entire book is similar to the way of determining the review summary information through the read book content in the aforementioned embodiments of the present disclosure, and will not be repeated here. As for the trial book content, the book content may be intercepted from the book content corresponding to the first chapter, such as the classic passages collected by a larger number of users in the reading platform, or the first paragraph of text or part of the text intercepted in the first paragraph of text, as the trial book content, so as to enable the user to understand the book which has not been read through the trial book content in different aspects, and the specific way is likewise not limited herein.

Exemplarily, FIG. 6 is another schematic diagram of displaying preview information of a target display element on a user collection page provided by an embodiment of the present disclosure, where the target display element indicates a book that has not been read. For comparison, the preview information corresponding to the read book A shown in FIG. 5 is comparatively replaced with the preview information corresponding to the unread book B in FIG. 6. Specifically, the preview information corresponding to book B in FIG. 6 includes the abstract information of the book and the trial book content, so that the user, after viewing the preview information displayed, has a general understanding of the book content in order to select whether or not to read the book in detail.

(1.2) Determining the preview information when the target display element indicates a book list.

In this case, the number of books in the target display element is more than one. Specifically, the plurality of target books indicated by the target display element may be determined, and the preview information may be determined based on the book information corresponding to each of the target books.

Here, as the book list is specifically indicated by the target display element, the focus is on the plurality of books included having a common book characteristic, such as the book list provided in the aforementioned example, where all eight books are biographies. In this case, compared to the aforementioned embodiments in which the preview information of the book is displayed, the focus is on displaying the specific book content contained therein. Because of the large number of books in the book list, if all the specific book content is displayed, it will result in displaying too much information, which aggravates the user's reading burden, and it is also difficult to express the group characteristics of the books that are unique to the book list. Therefore, in the embodiments of the present disclosure, the preview information is specifically selected to be determined based on the book information corresponding to each target book.

Here, the book information may be conventionally set to the classification of the book (e.g., recent or modern, etc.), the author of the book, or used to indicate whether or not the user has read the book. In addition, it is also possible to express the unique characteristics of the book list. For example, for the book list of biographies illustrated in the aforementioned example, it is possible to display the unique characteristics of each book as preview information around the group characteristics of “biography”. For example, the specific character described in each book may be used as the preview information, or the occupation of the described character may be used as the preview information, so that under the category of biography, the differences between the books can be described by utilizing the book information as the preview information.

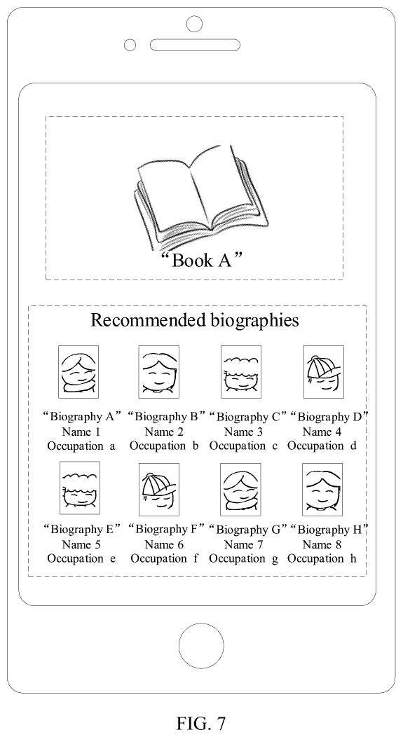

Exemplarily, FIG. 7 is a schematic diagram of displaying preview information of a target display element on a user collection page provided by an embodiment of the present disclosure, where the target display element indicates a book list. The preview information in FIG. 7 specifically includes the cover and the name of each book in the book list and the name and occupation of the person described in each book in the book list. In the actual display, for a plurality of biographies, the user can understand the differences among the books in the book list through the displayed names and occupations, and select the biography of a character that the user would like to continue to read through a person or an occupation that the user is interested in, and thus the book information, which can be of the nature of summarizing and distinguishing, can also be helpful for the user's analytical judgments.

Second, for the case where the target display page includes the book recommendation page, because the book and the book list in the book recommendation page are usually books that have not been read by the user and are specifically recommended by the reading platform, the focus is more on introducing and recommending the books to the user. Similar to the case where the target display page includes the user collection page as described aforementioned, the following describes the different cases where the target display element specifically indicates the book and the book list.

(2.1) Determining the preview information when the target display element indicates a book.

In this case, the number of books of the target display element is one. The book recommendation information corresponding to the target book indicated by the target display element may be acquired as the preview information.

Here, the book recommendation information may be specifically determined by a book recommendation reason, book information, book content, and the like. For the book recommendation reason, the book recommendation information may be determined based on the recommendation reason provided by the user of the reading platform for the target book, or the recommendation reason determined by the reading platform itself. For the book information and the book content, specific reference may be provided to the description in the aforementioned embodiments, which will not be repeated herein.

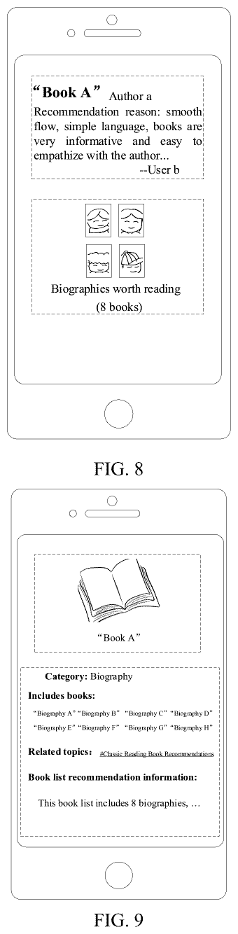

Exemplarily, FIG. 8 is a schematic diagram of displaying preview information of a target display element on a book recommendation page provided by an embodiment of the present disclosure, where the target display element indicates a book. In the displayed preview information, the book name, the author, and the recommendation reason corresponding to the recommended target book “Book C” are specifically included, and the recommendation reason is specifically determined from the recommendation reasons provided by other users in the reading platform, and thus the source of the data for uploading the recommendation reason is additionally labeled.

(2.2) Determining the preview information when the target display element indicates a book list.

In this case, the number of books for the target display element is more than one. Specifically, the target book list indicated by the target display element may be determined to determine the corresponding preview information based on the book list introduction information of the target book list.

Here, unlike the aforementioned-described display of the preview information corresponding to the book list in the user collection page, because displaying the preview information of the book list in the book recommendation page is more focused on recommending the book list as a whole, the corresponding preview information is specifically selected to be determined using the book list introduction information in embodiments of the present disclosure embodiments. Exemplarily, the book list introduction information may specifically include a book category, a topic, a book testimonial, and the like to which the plurality of books in the book list belong. In addition, the book list introduction information may be determined specially by utilizing the book information, the book recommendation information, and the like corresponding to each book.

Exemplarily, FIG. 9 is a schematic diagram of displaying preview information of a target display element on a book recommendation page provided by an embodiment of the present disclosure, where the target display element indicates a book list. Taking the book list as an example of the book list containing a plurality of biographies in FIG. 2, when displaying the preview information, the category to which the book list belongs, “Biography”, the book names corresponding to the plurality of books contained therein, the associated topic “#Classic Reading Books Recommended”, and the book list recommendation information of the book list. The associated topic can be clicked to jump to a topic discussion page, and the user can discuss the books in the book list in the topic discussion page.

In the aforementioned embodiments, the book of the text genre and the book list containing the books in the text genre are specifically illustrated, and in other possible cases, the books displayed or the book list containing the books, specifically, may also be of the image genre, such as a comic book, a photography album, and the like, as illustrated in the aforementioned embodiments.

In this approach, unlike textual information, it is difficult to display images by means of interception or information splicing because the images have a certain pixel value size and a complete image in order to express semantic information. Therefore, for the case where the content genre corresponding to the target display element includes the image genre, when updating to display the preview information corresponding to the target display element, a display position corresponding to at least one to-be-displayed image in the preview information may be determined in the target display page, so as to display the preview information based on the display position; the to-be-displayed image belongs to the book content of the book corresponding to the target display element.

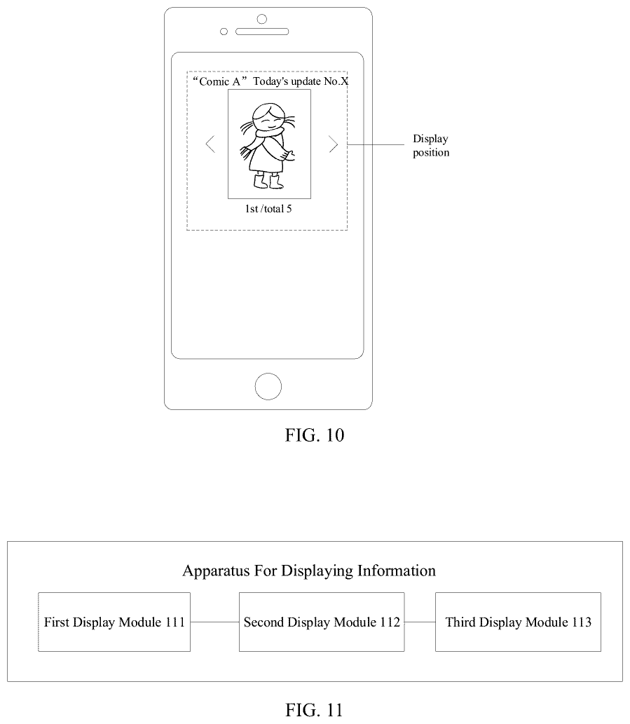

Exemplarily, referring to FIG. 10, FIG. 10 is a schematic diagram of displaying preview information corresponding to a target display element of an image genre provided by an embodiment of the present disclosure. In the example, the target display element specifically indicates a comic book. In the target display page, when setting the display position of the preview information, it may be determined based on the size of the smallest optional display of the to-be-displayed image, or a fixed display area size may be set to determine the display position.

For the preview information that can be displayed in the display position, it may specifically be an image, such as an image corresponding to a frame of comic in a comic book, or an image corresponding to a photography work in a photography album, which can be specifically selected from the book content of the book. In addition, a plurality of images may also be displayed when displaying, and a switchable way of displaying a plurality of images by tiling, a way of displaying a plurality of images by flipping a page, and the like may be provided so that the user can select a suitable preview method according to his/her own needs. In the example illustrated in FIG. 10, the name of the comic “Comic A”, the update status “Today's Update No. X”, and the first frame of the comic in the newly updated chapter of the comic are displayed in the display position, and the total number of frames of the comic and the number of frames of the comic currently being previewed are displayed below the preview information. “1st/total 5”, and the user can switch to view other comic available for preview by swiping left and right.

In this way, through the aforementioned step S102, it is possible to provide preview information for selecting the target display element in the intermediate state, and specifically provide the preview information to the user in a focused manner according to the content type of the target display element and the target display page to which the target display element belongs, so as to be more targeted and convenient for the user to continue to obtain the content of interest. Because the user, when selecting the target display element, usually selects only one of the plurality of display elements displayed, when determining and displaying the preview information, less information is required to be obtained, and it is easier to quickly complete the response, and in addition, compared to reading the information corresponding to each book and/or book list, the user focuses on the preview information corresponding to the target display element currently being displayed, and the burden of reading is also relatively low.

For the S103 described aforementioned, for the selected target display element, the displayed preview information is also the information that ultimately enables the user to decide whether or not to continue reading. Therefore, for the displayed preview information, in one possible case, if the user continues to select the trigger, which indicates a willingness to view the book or the book list in detail, the reading information corresponding to the target display element may continue to be displayed.

Here, for the case where the target display element indicates a book, the corresponding reading information may be, for example, the book content of the book, and thus specifically may jump to the book reading page so that the user may continue reading the book. As for the case where the target display element indicates a book list, in one possible case, if each book in the book list has been displayed in the preview information corresponding to the book list, the corresponding reading information may be displayed by triggering an operation in the preview information on the information related to any of the books. For example, a book reading page is displayed similarly to the case of the book described aforementioned, or if the preview information shown in FIG. 7 in the example contains encyclopedic information having associations with a name and an occupation, the associated encyclopedic information may also be provided in response to the triggering operation of the corresponding displayed preview information, and so forth, as may be determined in accordance with the actual situation.

In another possible case, if the user selects close, the target display page may be restored to the page displaying the at least one display element, so as to continue to execute the method for displaying information in the aforementioned embodiment according to the target display element next selected by the user, which will not be repeated herein.

The person skilled in the art may understand that in the aforementioned method of the specific embodiment, the order in which the steps are written does not imply any limitation of the implementation process by a strict order of execution, and the specific order of execution of the steps should be determined by their functions and possible internal logic.

Based on the same inventive concept, embodiments of the present disclosure further provide an apparatus for displaying information corresponding to the method for displaying information, and because the apparatus in embodiments of the present disclosure solves the problem in a similar principle to the aforementioned-described method for displaying information in embodiments of the present disclosure, the implementation of the apparatus can be referred to the implementation of the method, which will not be repeated.

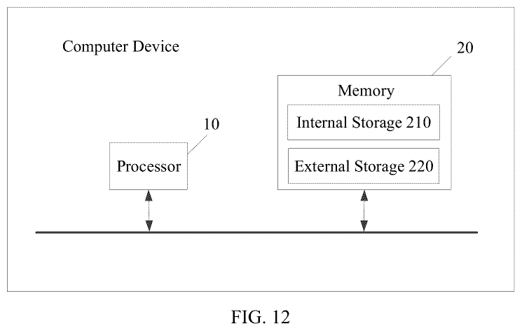

Referring to FIG. 11, a schematic diagram of an apparatus for displaying information provided by an embodiment of the present disclosure is shown, the apparatus includes: a first display module 111, a second display module 112, and a third display module 113.

The first display module 111 is configured to display at least one display element in a target display page, different display elements characterizing different content types, the different content types including different content genres and/or different numbers of books associated with the display element.

The second display module 112 is configured to, in response to a target display element among the at least one display element being selected, update to display preview information corresponding to the target display element in the target display page, the preview information being associated with a content type of the target display element;

The third display module 113 is configured to display reading information corresponding to the target display element in response to a triggering operation on the preview information of the target display element.

In an optional embodiment, in the target display page, the target display element is displayed in a target area in a form of card display; the second display module 112, when in response to a target display element among the at least one display elements being selected, updating to display preview information corresponding to the target display element in the target display page, is configured to: in response to the target display element being selected, display a flip effect in the form of card display in the target area, and update to display the preview information in the target area after the flip effect ends being displayed.

In an optional embodiment, the second display module 112, when in response to a target display element among the at least one display element being selected, updating to display preview information corresponding to the target display element in the target display page, is configured to: in response to the target display element being selected, enlarge the size of a first area in which the preview information is displayed to obtain a second area after enlarging, and display the target display element in the second area where the size of the second area is determined based on the amount of information in the preview information and a threshold of the maximum amount of information that can be carried in the second area.

In an optional embodiment, in response to the target display page including a user collection page, the preview information corresponding to the target display element is determined in the following manner: in response to the number of books of the target display element being one, determining the preview information based on a book content corresponding to a target book indicated by the target display element; or, in response to the number of books of the target display element being more than one, determining a plurality of target books indicated by the target display element and determining the preview information based on book information corresponding to the plurality of target books.

In an optional embodiment, in response to the target display page including a book recommendation page, the preview information corresponding to the target display element is determined in the following manner: in response to the number of books of the target display element being one, obtaining book recommendation information corresponding to a target book indicated by the target display element as the preview information; or, in response to the number of books of the target display element being more than one, determining a target booklist indicated by the target display element to determine the preview information based on booklist introduction information corresponding to the target booklist.

In an optional embodiment, in response to the preview information being determined based on a book content of a book, the method further includes determining the preview information in the following manner: determining a reading progress corresponding to the book; in response to the reading progress characterizing having read the book, determining review summary information and/or abstract information of a to-be-read content of the book based on the reading progress of the book, to determine the preview information of the book based on the review summary information and/or the abstract information of the to-be-read content, where the review summary information is determined by utilizing a read book content obtained from the book content based on the reading progress and the abstract information of the to-be-read content is determined by utilizing a to-be-read book content obtained from the book content based on the reading progress.

In an optional embodiment, further including determining the preview information in the following manner: in response to the reading progress characterizing not having read the book, determining book abstract information for introducing the book based on the book content of the book, and obtaining a trial book content corresponding to the first chapter of the book to determine the preview information based on the book abstract information and the trial book content.

In an optional embodiment, the content genre corresponding to the target display element includes an image genre; the second display module 112, when updating to display preview information corresponding to the target display element, is configured to: in response to the content genre corresponding to the target display element being the image genre, determine a display position corresponding to at least one to-be-displayed image in the preview information in the target display page for displaying the preview information based on the display position, the to-be-displayed image belonging to a book content of a book corresponding to the target display element.

The description of the processing flow of the modules in the apparatus, and the interaction flow between the modules can be referred to the relevant description in the aforementioned method embodiments, and will not be described in detail herein.

An embodiment of the present disclosure further provides a computer device. As shown in FIG. 12, a structural schematic diagram the computer device provided in an embodiment of the present disclosure. The computer device includes: at least one processor 10 and at least one memory 20.

The memory 20 stores machine-readable instructions executable by the processor 10, and the processor 10 is configured to execute the machine-readable instructions stored in the memory 20. When the machine-readable instructions are executed by the processor 10, the processor 10 implements the following steps:
displaying at least one display element in a target display page, different display elements characterizing different content types, the different content types including different content genres and/or different numbers of books associated with the display element; updating to display preview information corresponding to a target display element in the target display page in response to the target display element among the at least one display elements are selected, the preview information being associated with a content type of the target display element; and displaying reading information corresponding to the target display element in response to a triggering operation on the preview information of the target display element.

For example, the memory 20 includes an internal storage 210 and an external memory 220; the internal storage 210, also referred to as an internal memory, is configured for temporarily storing computing data in the processor 10, as well as data exchanged with an external memory 220, such as a hard disk, and the processor 10 exchanges data with the external memory 220 through the internal storage 210.

The specific implementation process of the aforementioned instructions can be referred to the steps of the information display method described in the embodiments of the present disclosure and will not be repeated herein.

An embodiment of the present disclosure further provides a non-transient computer-readable storage medium, computer programs are stored in the computer readable storage medium, and the computer programs upon being executed by the computer device, implement the steps of the method for displaying information described in the method embodiment aforementioned. The storage medium may be a volatile or nonvolatile computer-readable storage medium.

An embodiment of the present disclosure further provides a computer program product with program code, the program code including instructions that can be utilized to implement the steps of the information display method described in the aforementioned method embodiment. Specific reference may be found in the aforementioned method embodiments and will not be repeated herein.

The computer program product may be specifically implemented by hardware, software or a combination thereof. In one alternative embodiment, the computer program product is embodied as a computer storage medium, and in another alternative embodiment, the computer program product is embodied as a software product, such as a software development kit (SDK) and the like.

It can be clearly understood by those skilled in the art that, for convenience and simplicity of description, specific working processes of the system and the apparatus described above may refer to the corresponding processes in the foregoing method embodiment, which are omitted here. In the several embodiments provided in the present disclosure, it is to be understood that the disclosed system, apparatus, and method may be implemented in other manners. The above-described apparatus embodiments are merely illustrative. For example, the division of the units may be merely a logical function division, and in actual implementation, there may be another division mode. For another example, multiple units or components may be combined or integrated into another system, or some features may be omitted, or may not be executed. In addition, the displayed or discussed mutual couplings or direct couplings or communication connections may be implemented through some communication interfaces. The indirect couplings or communication connections between the apparatuses or units may be implemented in electronic, mechanical, or other forms.

The units described as separate parts may or may not be physically separate, and the components displayed as units may or may not be physical units, that is, they may be located in one position, or may be distributed on a plurality of network units. Some or all of the units may be selected according to actual needs to achieve the purposes of the solutions of the embodiments.

In addition, functional units in the embodiments of the present disclosure may be integrated into one processing unit, or each unit may exist alone physically, or two or more units may be integrated into one unit.

The functions, if implemented in software functional units and sold or used as a stand-alone product, may be stored in a nonvolatile computer-readable storage medium executable by a processor. Based on such understanding, the technical solutions of the present disclosure, which are essential or part of the technical solutions contributing to the related art, may be embodied in the form of a software product, which software product is stored in a storage medium and includes several instructions for causing a computer device (which may be a personal computer, a server, or a network device, etc.) to execute all or part of the steps of the methods described in the embodiments of the present disclosure. The aforementioned storage medium includes a U disk, a mobile hard disk, a read-only memory (ROM), a random-access memory (RAM), a magnetic disk or an optical disk and other media that can store program codes.

Finally, it should be noted that the above-mentioned embodiments are merely specific embodiments of the present disclosure, which are used to illustrate the technical solutions of the present disclosure, but not to limit the technical solutions, and the scope of protection of present disclosure is not limited thereto. Although the present disclosure is described in detail with reference to the foregoing embodiments, those of ordinary skill in the art should understand that any person familiar with the art can still make modifications or changes to the embodiments described in the foregoing embodiments, or make equivalent substitutions for some of the technical features, within the technical scope of the present disclosure; and such modifications, changes or substitutions do not make the essence of the corresponding technical solution deviate from the spirit and scope of the technical solutions of the embodiments of the present disclosure, and should be included in the scope of protection of the present disclosure. Therefore, the scope of protection of the present disclosure shall be subject to the scope of protection of the appended claims.

1. A method for displaying information, comprising:
displaying at least one display element in a target display page, different display elements characterizing different content types, the different content types comprising at least one selected from a group consisting of different content genres and different numbers of books associated with the display element;
in response to a target display element among the at least one display element being selected, updating to display preview information corresponding to the target display element in the target display page, wherein the preview information is associated with a content type of the target display element; and
displaying reading information corresponding to the target display element in response to a triggering operation on the preview information of the target display element.

2. The method according to claim 1, wherein in the target display page, the target display element is displayed in a target area in a form of card display;
the in response to a target display element among the at least one display element being selected, updating to display preview information corresponding to the target display element in the target display page, comprises:
in response to the target display element being selected, displaying a flip effect in the form of card display in the target area, and updating to display the preview information in the target area after the flip effect ends being displayed.

3. The method according to claim 2, wherein the in response to a target display element among the at least one display element being selected, updating to display preview information corresponding to the target display element in the target display page comprises:
in response to the target display element being selected, enlarging a size of a first area in which the preview information is displayed to obtain a second area after enlarging, and displaying the target display element in the second area,
wherein a size of the second area is determined based on an amount of information in the preview information and a threshold of a maximum amount of information that can be carried in the second area.

4. The method according to claim 1, wherein the in response to a target display element among the at least one display element being selected, updating to display preview information corresponding to the target display element in the target display page comprises:
in response to the target display element being selected, enlarging a size of a first area in which the preview information is displayed to obtain a second area after enlarging, and displaying the target display element in the second area; and
wherein a size of the second area is determined based on an amount of information in the preview information and a threshold of a maximum amount of information that can be carried in the second area.

5. The method according to claim 1, wherein in response to the target display page comprising a user collection page, the preview information corresponding to the target display element is determined in a following manner:
in response to a number of books of the target display element being one, determining the preview information based on a book content corresponding to a target book indicated by the target display element; or,
in response to a number of books of the target display element being more than one, determining a plurality of target books indicated by the target display element and determining the preview information based on book information corresponding to the plurality of target books.

6. The method according to claim 1, wherein in response to the target display page comprising a book recommendation page, the preview information corresponding to the target display element is determined in a following manner:
in response to a number of books of the target display element being one, obtaining book recommendation information corresponding to a target book indicated by the target display element as the preview information; or,
in response to a number of books of the target display element being more than one, determining a target booklist indicated by the target display element to determine the preview information based on booklist introduction information corresponding to the target booklist.

7. The method according to claim 6, wherein in response to the preview information being determined based on a book content of a book, the method further comprises determining the preview information in a following manner:
determining a reading progress corresponding to the book;
in response to the reading progress characterizing having read the book, determining at least one selected from a group consisting of review summary information and abstract information of a to-be-read content of the book based on the reading progress of the book, to determine the preview information of the book based on the at least one selected from the group consisting of the review summary information and the abstract information of the to-be-read content, wherein
the review summary information is determined by utilizing a read book content obtained from the book content based on the reading progress and the abstract information of the to-be-read content is determined by utilizing a to-be-read book content obtained from the book content based on the reading progress.

8. The method according to claim 7, further comprising:
in response to the reading progress characterizing not having read the book, determining book abstract information for introducing the book based on the book content of the book, and obtaining a trial book content corresponding to a first chapter of the book to determine the preview information based on the book abstract information and the trial book content.

9. The method according to claim 5, wherein in response to the preview information being determined based on a book content of a book, the method further comprises determining the preview information in a following manner:
determining a reading progress corresponding to the book;
in response to the reading progress characterizing having read the book, determining at least one selected from a group consisting of review summary information and abstract information of a to-be-read content of the book based on the reading progress of the book, to determine the preview information of the book based on the at least one selected from the group consisting of the review summary information and the abstract information of the to-be-read content, wherein
the review summary information is determined by utilizing a read book content obtained from the book content based on the reading progress and the abstract information of the to-be-read content is determined by utilizing a to-be-read book content obtained from the book content based on the reading progress.

10. The method according to claim 9, further comprising:
in response to the reading progress characterizing not having read the book, determining book abstract information for introducing the book based on the book content of the book, and obtaining a trial book content corresponding to a first chapter of the book to determine the preview information based on the book abstract information and the trial book content.

11. The method according to claim 1, wherein the content genre corresponding to the target display element comprises an image genre;
the updating to display preview information corresponding to the target display element, comprising:
in response to the content genre corresponding to the target display element being the image genre, determining a display position corresponding to at least one to-be-displayed image in the preview information in the target display page for displaying the preview information based on the display position, wherein the to-be-displayed image belongs to a book content of a book corresponding to the target display element.

12. A computer device, comprising:
at least one processor and at least one memory,
wherein the at least one memory stores machine-readable instructions executable by the processor, the at least one processor is configured to execute the machine-readable instructions stored in the at least one memory, and the machine-readable instructions, upon being executed by the at least one processor, implement a method for displaying information, the method for displaying information comprising:
displaying at least one display element in a target display page, different display elements characterizing different content types, the different content types comprising at least one selected from a group consisting of different content genres and different numbers of books associated with the display element;
in response to a target display element among the at least one display element being selected, updating to display preview information corresponding to the target display element in the target display page, wherein the preview information is associated with a content type of the target display element; and
displaying reading information corresponding to the target display element in response to a triggering operation on the preview information of the target display element.

13. The computer device according to claim 12, wherein in the target display page, the target display element is displayed in a target area in a form of card display;
the in response to a target display element among the at least one display element being selected, updating to display preview information corresponding to the target display element in the target display page, comprises:
in response to the target display element being selected, displaying a flip effect in the form of card display in the target area, and updating to display the preview information in the target area after the flip effect ends being displayed.

14. The computer device according to claim 13, wherein the in response to a target display element among the at least one display element being selected, updating to display preview information corresponding to the target display element in the target display page comprises:
in response to the target display element being selected, enlarging a size of a first area in which the preview information is displayed to obtain a second area after enlarging, and displaying the target display element in the enlarged second area,
wherein a size of the second area is determined based on an amount of information in the preview information and a threshold of a maximum amount of information that can be carried in the second area.

15. The computer device according to claim 12, wherein in response to the target display page comprising a user collection page, the preview information corresponding to the target display element is determined in a following manner:
in response to a number of books of the target display element being one, determining the preview information based on a book content corresponding to a target book indicated by the target display element; or
in response to a number of books of the target display element being more than one, determining a plurality of target books indicated by the target display element and determining the preview information based on book information corresponding to the plurality of target book.

16. The computer device according to claim 12, wherein in response to the target display page comprising a book recommendation page, the preview information corresponding to the target display element is determined in a following manner:
in response to a number of books of the target display element being one, obtaining book recommendation information corresponding to a target book indicated by the target display element as the preview information; or
in response to a number of books of the target display element being more than one, determining a target booklist indicated by the target display element to determine the preview information based on booklist introduction information corresponding to the target booklist.

17. The computer device according to claim 16, wherein in response to the preview information being determined based on a book content of a book, the method further comprises determining the preview information in a following manner:
determining a reading progress corresponding to the book;
in response to the reading progress characterizing having read the book, determining at least one selected from a group consisting of review summary information and abstract information of a to-be-read content of the book based on the reading progress of the book, to determine the preview information for the book based on the at least one selected from the group consisting of the review summary information and/or the abstract information of the to-be-read content,
wherein the review summary information is determined by utilizing a read book content obtained from the book content based on the reading progress and the abstract information of the to-be-read content is determined by utilizing a to-be-read book content obtained from the book content based on the reading progress.

18. The computer device according to claim 17, further comprising:
in response to the reading progress characterizing not having read the book, determining book abstract information for introducing the book based on the book content of the book, and obtaining a trial book content corresponding to a first chapter of the book to determine the preview information based on the book abstract information and the trial book content.

19. The computer device according to claim 12, wherein the content genre corresponding to the target display element comprises an image genre; and
the updating to display preview information corresponding to the target display element, comprises:
in response to the content genre corresponding to the target display element being the image genre, determining a display position corresponding to at least one to-be-displayed image in the preview information in the target display page for displaying the preview information based on the display position, wherein the to-be-displayed image belongs to a book content of the book corresponding to the target display element.

20. A non-transient computer-readable storage medium, wherein the non-transient computer-readable storage medium stores computer programs, and the computer programs, upon being run by a computer device, implement a method for displaying information, the method for displaying information comprising:
displaying at least one display element in a target display page, different display elements characterizing different content types, the different content types comprising at least one selected from a group consisting of different content genres and different numbers of books associated with the display element;
in response to a target display element among the at least one display element being selected, updating to display preview information corresponding to the target display element in the target display page, wherein the preview information is associated with a content type of the target display element; and
displaying reading information corresponding to the target display element in response to a triggering operation on the preview information of the target display element.
